(19) United States
(12) Patent Application Publication
(10) Pub. No.: US 2008/0080406 A1
(43) Pub. Date: Apr. 3, 2008

(54) METHOD AND DEVICE FOR INCREASING CAPACITY OF TDD WIRELESS COMMUNICATION SYSTEMS

(75) Inventors: Neil R. Peplinski, N. Barrington, IL (US); William K. Doss, Lake in the Hills, IL (US); Thomas J. Kovarik, Grayslake, IL (US); Thomas J. Kundmann, Cary, IL (US); Alan P. Rottinghaus, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/536,813

(22) Filed: Sep. 29, 2006

(51) Int. Cl. H04L 5/14; H04B 7/204; H04Q 7/00

(52) U.S. Cl. 370/294; 370/295; 370/319; 370/328

(57) ABSTRACT

An access point (108) in a dual-frequency TDD communication system (100) includes a transceiver (122) that transmits information to a first group of subscriber devices (104a-n) at a first frequency (f₁) and contemporaneously receives information from a second group of a subscriber devices (106a-n) at a second frequency (f₂) during at least a portion of a period of time (T1). The access point (108) also transmits information to the second group of subscriber devices (106a-n) at the second frequency (f₂) and contemporaneously receives information from the first group of subscriber devices (104a-n) at the first frequency (f₁) during at least a portion of a second period of time (T3). A method for performing a dual-frequency communication scheme is also provided.

### FIELD OF THE INVENTION

The present invention generally relates to the field of wireless communications, and more particularly relates to increasing hardware utilization in TDD wireless communication systems.

### BACKGROUND OF THE INVENTION

Wireless communication systems have evolved greatly over the past few years. Current wireless communication systems are capable of transmitting and receiving voice and data and broadband content such as streaming video and audio. One communication scheme used in today's wireless communication systems is time division duplex (“TDD”). “Duplex” communication systems are those in which a signal can flow in both directions between connected parties. These systems are employed in nearly all communications networks, either to allow for a “two-way street” between connected parties or to provide a “reverse path” for the monitoring and remote adjustment of equipment in the field.

Prior art TDD schemes allow for the transmission and reception of data on a single frequency. In these conventional TDD systems, the AP transmitter transmits and then is silent while its receiver is receiving. This results in continuously repeating periods of time when the AP hardware is underutilized.

Therefore a need exists to overcome the problems with the prior art as discussed above.

### SUMMARY OF THE INVENTION

Embodiments of the present invention provide an access point for a TDD communication system that communicates with subscriber wireless devices at a first frequency and at a second frequency. In one embodiment, the access point includes a transceiver that transmits information to a first group of subscriber wireless devices at a first frequency and contemporaneously receives information from a second group of subscriber wireless devices at a second frequency during at least a portion of a first period of time. The access point also transmits information to the second group of subscriber wireless devices at the second frequency and contemporaneously receives information from the first group of subscriber wireless devices at the first frequency during at least a portion of a second period of time.

In embodiments of the present invention, the first period of time and the second period of time occur consecutively over time.

In accordance with an added feature of the invention, a transition period separates the first period of time and the second period of time.

In accordance with yet another feature of the invention, the information comprises at least one of voice, text, data, video, sound, and graphics.

In accordance with yet a further feature of the invention, the transmitting and receiving are in compliance with a standard protocol, which, in one embodiment is 802.16e.

Embodiments of the present invention also include a method for communicating in a TDD communication system that communicates with subscriber devices at a first frequency and at a second frequency. One embodiment of the method includes transmitting information to a first group of subscriber devices at a first frequency during a first period of time, receiving, contemporaneously with the transmitting to the first group, information from a second group of subscriber devices at a second frequency, transmitting information to the second group of subscriber devices at the second frequency during a second period of time, and receiving, contemporaneously with the transmitting information to the second group, information from the first group of subscriber devices at the first frequency.

In accordance with an added feature of the invention, the method also includes repeating the transmitting at the first frequency contemporaneously with the receiving at the second frequency and the transmitting at the second frequency contemporaneously with receiving at the first frequency consecutively over time.

In accordance with an added feature of the invention, the method includes waiting for a transition period after transmitting the information to the first group and before transmitting the information to the second group.

An advantage of the foregoing embodiments of the present invention is that periods of underutilization of the AP hardware is greatly reduced.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an exemplary wireless communications system, according to an embodiment of the present invention;

FIG. 2 is a block diagram illustrating an exemplary information processing system, according to an embodiment of the present invention;

FIG. 3 is a block diagram illustrating an exemplary wireless communication device, according to an embodiment of the present invention;

FIG. 4 is graphical representation of a prior art single-frequency TDD communication protocol;

FIG. 5 is graphical representation of a dual-frequency TDD communication protocol;

FIG. 6 is block diagram illustrating the exemplary wireless communications system of FIG. 1, with a second group of subscriber devices, according to an embodiment of the present invention; and

FIG. 7 is an operational flow diagram illustrating an exemplary process of dual-frequency TDD communication, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The presently claimed invention, according to an embodiment, overcomes problems with the prior art by optimizing the hardware responsible for wireless communication of information to wireless communication devices. An embodiment of the present invention increases hardware utilization in TDD systems by using multiple frequencies at the system access point (AP) to operate a secondary TDD link out of phase with the primary.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, a PDA, an automotive gateway, a residential gateway, and the like.

Exemplary Wireless Communications System

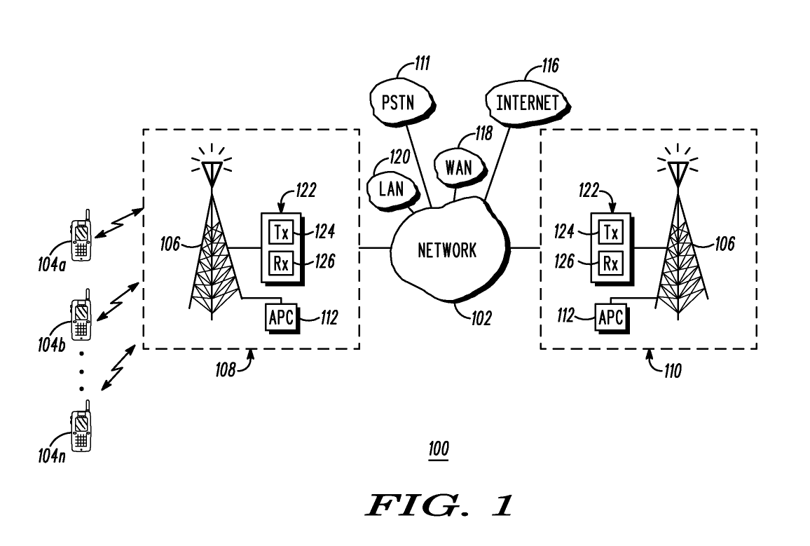

According to an embodiment of the present invention, as shown in FIG. 1, an exemplary wireless communications system 100 is illustrated. FIG. 1 shows a wireless communications network 102 that connects wireless communication “subscriber” devices 104a-n to a central server and/or to wireline networks like the Public Switched Telephone Network (PSTN) 111, public internet 116, LANs, and others. It can also provide subscriber to subscriber access without any external network/server involvement.

The wireless communications network comprises a mobile phone network, a mobile text messaging device network, a pager network, or the like. An embodiment of the wireless communication network, in accordance with the present invention, is a wireless broadband data network (fixed and/or mobile). Further, the communications standard of the wireless communications network of FIG. 1 includes Code Division Multiple Access (CDMA), Time Division Multiple Access (TDMA), such as Global System for Mobile Communications (GSM) and General Packet Radio Service (GPRS), Frequency Division Multiple Access (FDMA), Orthogonal Frequency Division Multiplexing (OFDM), or the like. Additionally, the wireless communications network also includes broadband data, VoIP, streaming video/audio, text messaging standards, for example, Short Message Service (SMS), Enhanced Messaging Service (EMS), Multimedia Messaging Service (MMS), or the like. The wireless communications network also allows for push-to-talk over cellular communications between capable wireless communication devices. The wireless network supports any number and type of subscriber devices 104a-n and communication between such devices and access points.

In an exemplary embodiment, the wireless communications network is capable of broadband wireless communications utilizing time division duplexing (“TDD”) as set forth, for example, by the IEEE 802.16e standard. The IEEE 802.16e standard is further described in IEEE Std. 802.16e-2005. As will be explained in detail below, the TDD duplexing scheme of the present invention allows for the transmissions of signals in out-of-phase downstream and upstream directions using two frequencies. It should be noted that the present invention is not limited to an 802.16e system for implementing the dual-frequency TDD scheme. Other such standards such as UMTS LTE (Long Term Evolution), and IEEE 802.20 are also applicable.

The wireless communications system 100 also includes one or more APs 108, 110 that serve as access points (AP) for communication between the subscriber devices 104a-n and the rest of the system. Each AP 108, 110 is equipped with an antenna 106 and a transceiver 122 that includes a transmitter 124 and a receiver 126 for wirelessly communicating with the plurality of subscriber devices 104a-n within coverage of the APs 108, 110. Although the subscriber devices 104a-n are shown communicating with AP 108 only, any or all of the subscriber units can move to a cell covered by AP 110 and receive coverage by AP 110.

If more than one AP is utilized, the APs 108, 110 are synchronized with one another. Each AP 108, 110, in one embodiment, includes an AP controller (“APC”) 112. In embodiments of the present invention, the elements of transceivers 122, APCs 112, and antennas 106 may be physically separated or integrated. The synchronization of the access points, in one embodiment, is a time-based synchronization for transmitting and/or receiving wireless data.

In the TDD scheme according to the present invention, a number of subscriber devices 104a-n are organized into groups. The TDD synchronization between the APs 108, 110 ensures that respective subscriber devices 104a-n in a single group are not transmitting while the other subscriber devices in the same group are receiving, and vice-versa.

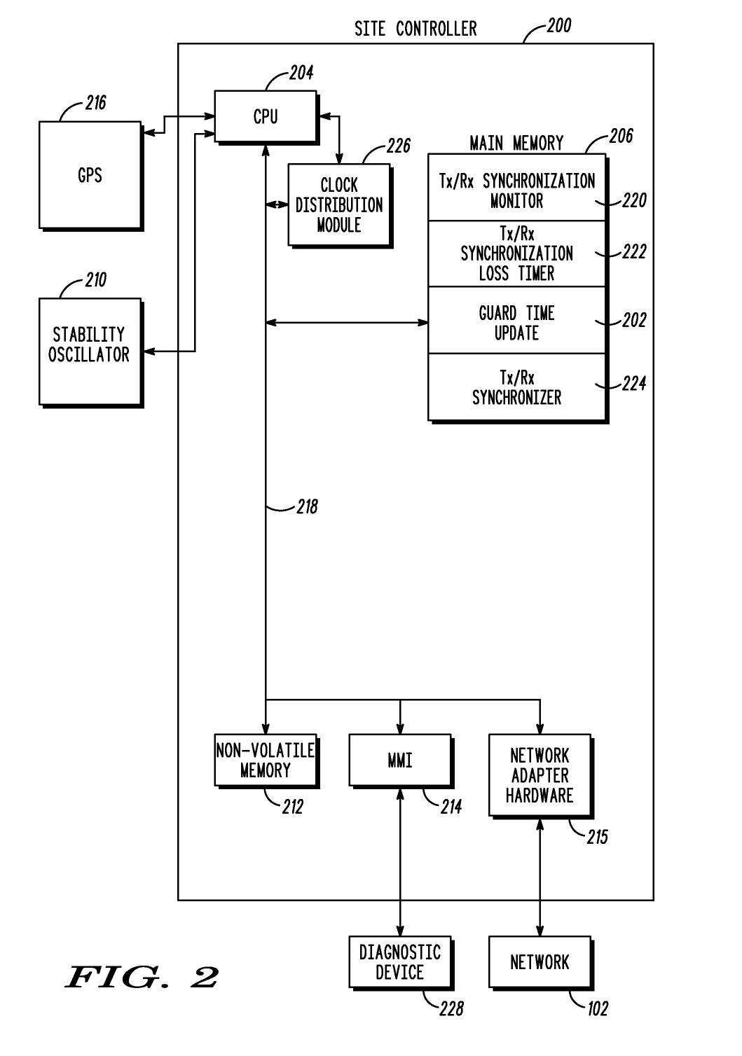

Each AP 108, 110 (or APC 112 that is coupled to the AP 108, 110) includes, in one embodiment, a synchronization means such as a GPS receiver 216 (FIG. 2) for synchronizing the AP 108, 110 with other APs in the TDD system. It should be noted that the timing synchronization is not limited to using GPS.

The subscriber devices 104a-n in one embodiment, are capable of wirelessly communicating data using the 802.16e standard or any other communication scheme that supports TDD. As the subscriber devices 104a-n enter a cell, they are synchronized with an AP serving that cell. For example, as the subscriber devices 104a-n enter a cell served by AP 108, they access a TDD ranging channel. A downlink frame received by the subscriber devices 104a-n from AP 108 includes a preamble which gives the subscriber devices 104a-n basic synchronization information. An AP, via the APC 112, can determine a timing delay of a subscriber device based on information received from the device such as on a ranging channel. The AP 108, 110 can then signal the subscriber devices 104a-n to either advance or retard their timing so that the subscriber devices 104a-n are synchronized with other subscriber devices 104a-n in the system. The ranging channel is on the reverse link (from subscriber device to AP) and the signaling of timing advance is on the forward link (from AP to subscriber device).

The synchronization between the subscriber devices 104a-n in a group is a timing synchronization for wirelessly transmitting and receiving data. Therefore, the subscriber devices 104a-n within a single group all transmit and receive data at substantially the same time.

Additionally, the wireless communication system 100 is capable of communicatively coupling the subscriber devices 104a-n to a wide area network 118, a local area network 120, a public switched telephone network 111, the internet 116, and the like, through the wireless communications network 102. Each of these networks has the capability of sending data, for example, a multimedia text message to the subscriber devices 104a-n.

Exemplary Information Processing System

FIG. 2 is a block diagram illustrating a detailed view of an APC 200, such as APC 112, according to an embodiment of the present invention. The APC 200, in one embodiment, resides within its respective AP 108, 110. In another embodiment, the APC 200 resides outside of and is communicatively coupled to its respective AP 108, 110. The APC 200 includes a processor 204 that is communicatively connected to a main memory 206 (e.g., volatile memory), the TX/RX timing synchronization means 216, a stability oscillator 210, non-volatile memory 212, a man-machine interface (“MMI”) 214, a clock generator 226, and a network adapter hardware 215. A system bus 218 interconnects these system components. The main memory 206 includes a TX/RX synchronization monitor 220, a TX/RX synchronization loss timer 222, a guard time updater 202, and a TX/RX synchronizer 224. In one embodiment, these components are algorithms that can be executing in the CPU 204. Parameters for these components can reside in the main memory 206. In another embodiment, these components can be hardware components residing outside of the main memory 206. The MMI 214, in one embodiment, is used to directly connect one or more diagnostic devices 228 to the APC 200.

The TX/RX timing synchronization means 216, in one embodiment, is a Global Positioning System (“GPS”) module, which provides a master clock source for the APC 200. For example, the CPU 204 receives the clock source from the GPS module 216 and passes this clock source to a clock distribution module 226. Clock signals for the respective components of the AP 108 are generated, in one embodiment, by the clock distribution module 226 based on the master clock source received from the GPS module 216.

The master clock source provides a timing reference for its AP, which is used to synchronize itself and its respective wireless communication devices for transmission and reception of wireless data. A TX/RX synchronizer 224 uses the timing reference to synchronize the AP for wirelessly transmitting and receiving data. Each of the APs 108, 110 in the wireless communication system 100 are synchronized to a substantially common synchronization timing. In other words, the TX/RX timing synchronization means 216 communicatively coupled to each AP 108, 110 generates a substantially common synchronization timing signal. Therefore, the transmission and reception of data by each AP 108, 110 is synchronized with the other APs 108, 110 in the wireless communication system. For example, the APs 108, 110 are synchronized so that downlink and uplink subframes in a TDD communication frame transmitted by each AP 108, 110 are aligned. In other words, the synchronization ensures that any of the subscriber devices 104a-n of AP 108 are not transmitting/receiving while any other subscriber devices of the TDD system are receiving/transmitting.

In one embodiment, the TX/RX timing synchronization is predefined and common among all of the APs 108, 110. In one embodiment, wireless communication devices that are coupled to the AP 108 are also synchronized for transmission and reception of data. For example, the preamble of a downlink frame includes synchronization information for synchronizing one or more respective subscriber devices 104a-n.

The stability oscillator 210, in one embodiment, is a medium stability oscillator, a high stability oscillator, or the like. The stability oscillator 210 acts as a back-up synchronization device if the TX/RX timing synchronization means 216 fails or if a timing reference signal is lost for any reason. For example, if the TX/RX timing synchronization means 216, the stability oscillator 210 provides a timing frame of reference to the clock distribution module 226. The stability oscillator 210 has a relatively slow drift rate, e.g., 0.8 μs per hour, which extends the survivability of the communications system 100. The synchronization of the APs 108, 110 with respect to a timing frame of reference that is common to the APs 108, 110, in one embodiment, is monitored by a TX/RX synchronization monitor 220.

The TX/RX synchronization monitor 220 detects when a loss of the timing reference has occurred. A timing reference loss can occur, for example, from a failure of the TX/RX timing synchronization means 216, loss of the GPS signal, and the like. Once a loss is detected, a TX/RX synchronization loss timer 222 starts to count a predefined time period. The TX/RX synchronization loss timer 222 is used to determine when a predefined period of time has passed since losing the time reference signal. In one embodiment, the predefined period of time correlates to a known amount of time that the stability oscillator can drift (e.g. maximum clock slip rate) before potential interference between subscriber devices 104a-n occurs.

The guard time updater 202 helps mitigate interference. For example, in an 802.16e system utilizing TDD, a frame comprises, among other things, a downlink portion, uplink portion, a transmit turn guard (“TTG”) portion, and a receive turn guard (“RTG”) portion. The transmit turn guard is a time period where the subscriber device 104 is transitioning from a transmitting mode to a receiving mode. In other words, the wireless communication device stops transmitting so that it can receive data from the AP 108. The receive turn guard is a time period where the subscriber device 104 is transitioning from a receiving mode to a transmitting mode.

Once the predefined time period corresponding to the maximum drift rate has passed, the guard time updater 202 decreases the available amount of transmission time for the AP 108 and its respective subscriber devices 104a-n by increasing the guard times in the frame. For example, the guard time updater 202 increases the TTG by one symbol time in both directions, e.g. before and after the TTG. The RTG is also increased by one symbol time in both directions. Therefore, the downlink portion, which is the portion of the frame where the AP 108 is transmitting, is decreased by two symbol times. The uplink portion of the frame, which is where subscriber devices 104a-n are transmitting, is also decreased by two symbol times. It should be noted that the TTG and RTG can be increased by more than one symbol time. It should also be noted that symbol times can be different and do not have to be fixed for all symbols.

When the timing reference is lost, uncertainty exists as to whether the AP 108 is transmitting/receiving at the same time, before, or after the other AP 110, thereby potentially causing interference. The adjustment of the guard times allows for this uncertainty to be removed. Adjusting the guard times prevents one subscriber device from transmitting to its AP while another subscriber device is listening to its AP and vice versa, which can cause interference.

The network adapter hardware 215 is used to provide an interface to the network 102. For example, the network adapter 215, in one embodiment provides the Ethernet connections 136, 138 between the AP 108, 110 and the wireless communications network 102. An embodiment of the present invention can be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 228, CD ROM, or other form of recordable media, or via any type of electronic transmission mechanism.

Exemplary Wireless Communication Device

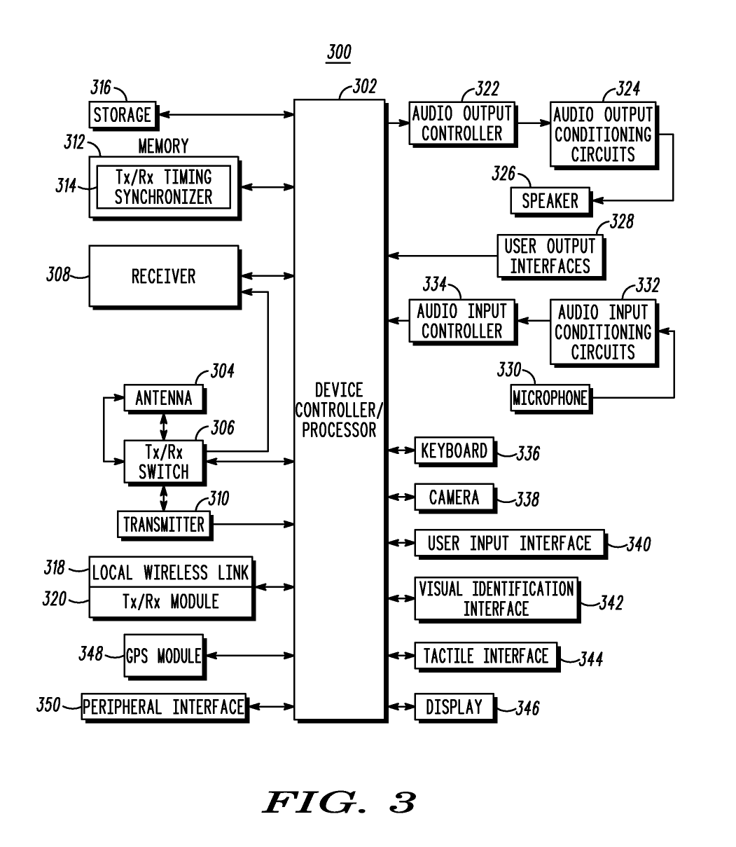

FIG. 3 is a block diagram illustrating a more detailed view of a subscriber device 300, such as subscriber devices 104a-n. In one embodiment, the subscriber device 300 is capable of transmitting and receiving wireless information on frequencies and with techniques consistent with protocols such as an 802.16e system using TDD. The subscriber device 300 operates under the control of a device controller/processor 302, that controls the sending and receiving of wireless communication signals. In receive mode, the device controller 302 electrically couples an antenna 304 through a transmit/receive switch 306 to a receiver 308. The receiver 308 decodes the received signals and provides those decoded signals to the device controller 302.

In transmit mode, the device controller 302 electrically couples the antenna 304, through the transmit/receive switch 306, to a transmitter 310. The device controller 302 operates the transmitter and receiver according to instructions stored in the memory 312. These instructions include, for example, a neighbor cell measurement-scheduling algorithm. The memory 312 also includes a TX/RX timing synchronizer 314. The TX/RX timing synchronizer 314 synchronizes the subscriber device 300 with its respective AP 108 for transmitting and receiving wireless information. For example, as the subscriber device 300 enters into a cell, it communicates with an AP, such as AP 108, via a ranging channel. The APC 112 determines, in one embodiment, a timing scheme needed to synchronize the subscriber device with the other subscriber devices and APs in the system 100. The subscriber device 300 receives a timing synchronization signal via the receiver 126 transmitted from the AP 108 on a reverse link. The timing synchronization signal instructs the TX/RX timing synchronizer 314 to advance or retard a timing reference of the subscriber device 300, thereby synchronizing the subscriber device 300 with the other devices in the system 100.

The subscriber device 300 also includes non-volatile storage memory 316 for storing, for example, an application waiting to be executed (not shown) on the subscriber device 300. The subscriber device 300, in this example, also includes an optional local wireless link 318 that allows the subscriber device 300 to directly communicate with another subscriber device without using a wireless network (not shown). The optional local wireless link 318, for example, is provided by Bluetooth, Infrared Data Access (IrDA) technologies, or the like. The optional local wireless link 318 also includes a local wireless link transmit/receive module 320 that allows the subscriber device 104 to directly communicate with another wireless communication device.

The subscriber device 300 of FIG. 3 further includes an audio output controller 322 that receives decoded audio output signals from the receiver 308 or the local wireless link transmit/receive module 320. The audio controller 322 sends the received decoded audio signals to the audio output conditioning circuits 324 that perform various conditioning functions. For example, the audio output conditioning circuits 324 may reduce noise or amplify the signal. A speaker 326 receives the conditioned audio signals and allows audio output for listening by a user. The audio output controller 220, audio output conditioning circuits 324, and the speaker 326 also allow for an audible alert to be generated notifying the user of a missed call, received messages, or the like. The subscriber device 300 further includes additional user output interfaces 328, for example, a head phone jack (not shown) or a hands-free speaker (not shown).

The subscriber device 300 also includes a microphone 330 for allowing a user to input audio signals into the subscriber device 300. Sound waves are received by the microphone 330 and are converted into an electrical audio signal. Audio input conditioning circuits 332 receive the audio signal and perform various conditioning functions on the audio signal, for example, noise reduction. An audio input controller 334 receives the conditioned audio signal and sends a representation of the audio signal to the device controller 302.

In some embodiments, the subscriber device 300 also comprises a keyboard 336 for allowing a user to enter information into the subscriber device 300. The subscriber device 300 further comprises a camera 338 for allowing a user to capture still images or video images into memory 314. Furthermore, the subscriber device 300 includes additional user input interfaces 340, for example, touch screen technology (not shown), a joystick (not shown), or a scroll wheel (not shown). In one embodiment, a peripheral interface 350 is also included for allowing the connection of a data cable to the subscriber device 300. The peripheral interface 350 allows the subscriber to act as a residential gateway providing, for example, an Ethernet data connection to the user. In another exemplary application, the peripheral connection 350 allows a subscriber to plug a PCMCIA card into a laptop. The card provides a wireless network connection for the laptop. In one embodiment of the present invention, the connection of a data cable allows the subscriber device 104 to be connected to a computer or a printer.

A visual notification (or indication) interface 342 is also included on the subscriber device 300 for rendering a visual notification (or visual indication), for example, a sequence of colored lights on the display 346 or flashing one or more LEDs (not shown), to the user of the subscriber device 300. For example, a received multimedia message may include a sequence of colored lights to be displayed to the user as part of the message. Alternatively, the visual notification interface 342 can be used as an alert by displaying a sequence of colored lights or a single flashing light on the display 346 or LEDs (not shown) when the subscriber device 104 receives a message, or the user missed a call.

The subscriber device 300 also includes a tactile interface 344 for delivering a vibrating media component, tactile alert, or the like. For example, a multimedia message received by the subscriber device 300, may include a video media component that provides a vibration during playback of the multimedia message. The tactile interface 344, in one embodiment, is used during a silent mode of the subscriber device 300 to alert the user of an incoming call or message, missed call, or the like. The tactile interface 344 allows this vibration to occur, for example, through a vibrating motor or the like.

The subscriber device 300 also includes a display 346 for displaying information to the user of the subscriber device 300 and an optional Global Positioning System (GPS) module 348. The optional GPS module 348 determines the location and/or velocity information of the subscriber device 300. This module 348 uses the GPS satellite system to determine the location and/or velocity of the subscriber device 300. Alternative to the GPS module 348, the subscriber device 300 may include alternative modules for determining the location and/or velocity of subscriber device 300, for example, using cell tower triangulation and assisted GPS.

Single-Frequency TDD Frames

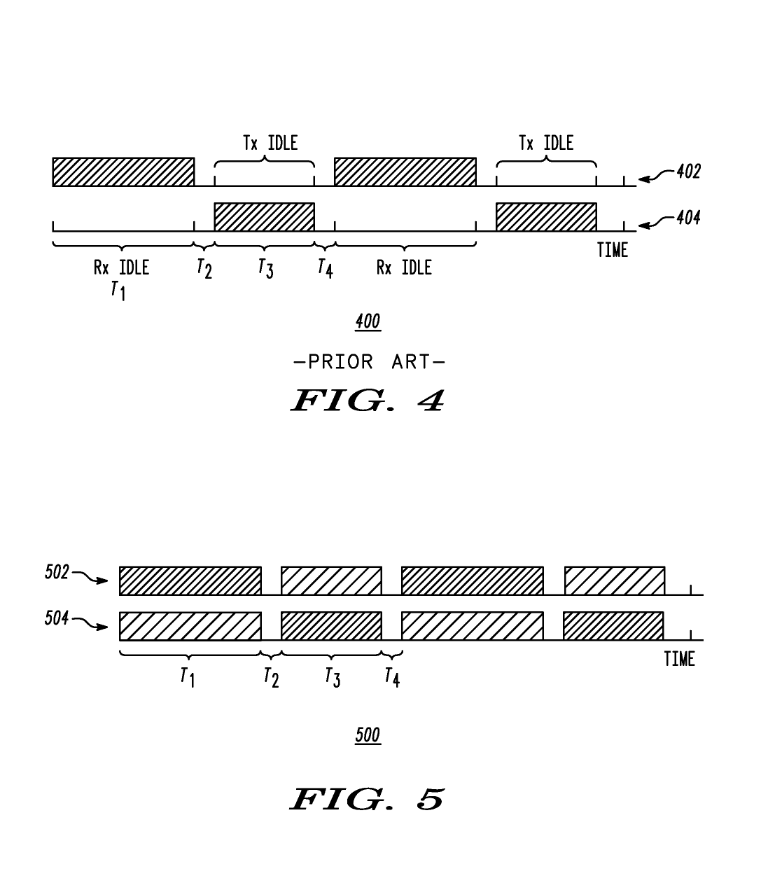

FIG. 4 shows a standard time frame 400 that includes a series of TDD transmission periods 402 and a set of TDD reception periods 404, such as is known and used with an 802.16e system, for example. In the conventional TDD system, an AP transmitter 108 transmits to a group of subscriber devices 104a-n in a single frequency, f₁. Because the transmission and reception frequencies are the same, the AP 108 cannot and does not receive while it is transmitting. Therefore, in a downlink period T1, the AP transmitter 124 is active and the AP receiver 126 is idle. After a transition period, known as a transmit turn guard, T2, the system switches to an uplink mode and for a period T3, the receiver 126 receives data from the subscriber devices 104a-n. During this time 410, the transmitter 124 sits idle. The AP 108 goes back into a second transmit turn guard T4 then enters the transmission mode again. The process continues on and on, where at all times, either the transmitter 124 or the receiver 126 is sitting idle, except the transition periods T2, T4, where both are idle. The single frequency TDD model is well known by those of ordinary skill in the art.

Dual-Frequency TDD Frames

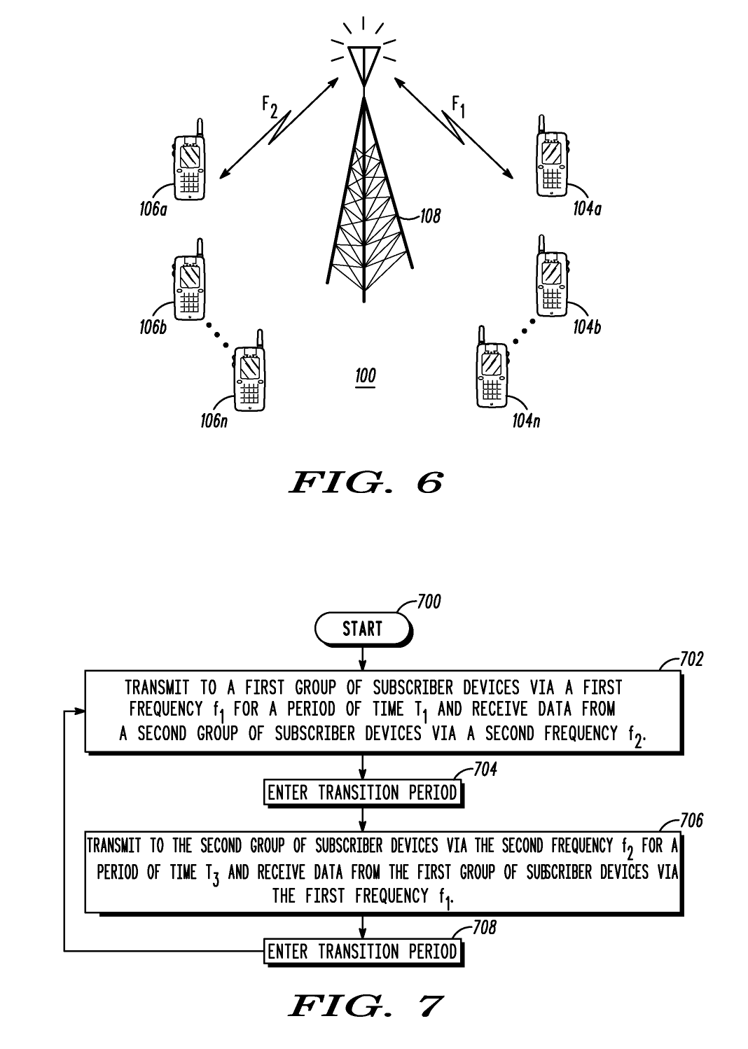

Described now is a specific embodiment of the dual-frequency wireless TDD communication scheme, according to the present invention. The inventive dual-frequency scheme, illustrated in FIG. 5, utilizes, instead of a single frequency as in the conventional TDD model, two separate frequencies, f₁ and f₂. As will now be explained, the present communication model allows an AP 108 to make full utilization of the previously idle times of its transmitter 124 and receiver 126. As a result, the AP 108 is able to contemporaneously communicate with two separate groups of subscriber devices, as shown in FIG. 6, within the same timeframe that was previously used to communicate with only a single group of subscriber devices.

FIG. 6 shows the same communication infrastructure 100 and group of subscriber devices 104a-n of FIG. 1. In this embodiment, the first group of subscriber devices 104a-n are communicating with the AP 108 on a first frequency, f₁. By utilizing the present invention, the communication infrastructure 100 is now able to contemporaneously communicate with at least a second group of subscriber devices 106a-n operating on a second frequency f₂. Each of the subscriber devices continues to communicate in compliance with the standard TDD communication scheme, but on their respective frequencies (f₁ or f₂). In this respect, the present invention provides the benefit of placing no requirement on the subscriber devices for additional hardware or software or replacement or modifications thereof.

Referring now back to FIG. 5, the present invention utilizes a time frame 500 that is analogous to the conventional time frame 400 in terms of length. The time frame 500 includes a primary link 502 that includes a set of transmit periods T1, T3, . . . and a secondary link 504 that includes a set of receive periods T1, T3, . . . . Each of the periods T1, T3, . . . in each of the links 502, 504 alternates between a first frequency f₁ and a second frequency f2, with the alternations of the links 502, 504 being 180 degrees out of phase with each other. By utilizing a second frequency, f₂, the present invention provides a secondary TDD link that is always out of phase with the primary link.

More specifically, in the first period T1 of the time frame 500, the AP transmitter 124 of AP 108 transmits to a first group of subscriber devices 104a-n in the first link 502 a first frequency, f₁. Contemporaneously with the transmission at frequency f₁, the receiver 126 receives data from the second group of subscriber devices 106a-n at the second frequency f₂ via the second link 504. Because the transmission and reception frequencies are different, the AP 108 is now able to receive while it is transmitting, and vice versa, without interference.

The AP 108 then enters a transmit turn guard period T2 where it switches, on the first link 502, from frequency f₁ to frequency f₂ and on the second link 504, from frequency f₂ to frequency f₁. Upon exiting the transmit turn guard period T2, the system enters the next period T3, where the AP 108 transmits on the first link 502 to the second group of subscriber devices 106a-n in the second frequency f₂ and receives data in the second link 504 from the first group of subscriber devices 104a-n in the first frequency f₁. At the end of the third period T3, the AP 108 enters a second transmit turn guard period T4, where it switches on the first link 502 back to the first frequency f₁ and on the second link back to the second frequency f₂. The process continues to alternate as shown in the remainder of FIG. 5.

As has now been described and shown in the illustration of FIG. 5, the transmitter 124 of the AP 108 continuously alternates between two links, one at frequency f₁ and the other at frequency f₂. Using the two links, the AP 108 now substantially continuously and sequentially alternates transmission of signals between the two groups of subscriber devices so that the primary link 502 is always out of phase with the secondary link 504. Likewise, the receiver 126 of the AP 108 continuously alternates between two frequencies, f₁ and f₂, so that it substantially continuously and sequentially alternates reception of signals from either the first group or the second group of subscriber devices.

Distinct from a frequency duplexed system (FDD), where receive and transmit functions are performed on separate frequencies, the present invention provides different groups of TDD subscriber devices operating on separate frequencies or frequency bands.

Exemplary Process of Transmitting in Dual-Frequency TDD Mode

FIG. 7 is an operational flow diagram illustrating an exemplary communication process in the dual-frequency TDD mode according to one embodiment of the present invention. The flow begins at step 700 and moves directly to step 702 where the AP 108 transmits to a first group of subscriber devices 104a-n in a first frequency f₁ for a period of time T₁. Contemporaneously, the AP 108 receives data from a second group of subscriber devices 106a-n on a second frequency f₂ for the same period of time T₁. Next, in step 704, the AP 108 enters a transmit turn guard period for a time T₂. During time T₂, the AP 108 stops transmitting and receiving. The flow then moves to step 706, where the AP 108 transmits to the second group of subscriber devices 106a-n on the second frequency f₂ for a period of time T₃. During that same time period T₃, the AP 108 also receives data from the first group of subscriber devices 104a-n on the first frequency f₁. At the end of T₃, the flow moves to step 708, where the AP 108 enters into a transmit turn guard period for a time T₄. During the transition period, similar to transition period T₂, the AP 108 ceases transmission and reception. Upon completion of transition period T₄, the flow moves back up to step 702 and repeats the flow from step 702 on.

Non-Limiting Examples

The foregoing embodiments of the present invention are advantageous because they provide a method of increasing hardware utilization and system capacity in TDD systems by using multiple frequencies at the system AP or access point to operate a secondary TDD link out of phase with the primary link. Through utilization of the present invention, during times when the AP transmitter is normally idle, it now communicates to another set of subscriber devices on a different frequency. The process operates similarly for the receive side. The present invention is advantageous as it provides a low-cost, multi-carrier AP implementation without any need to modify currently used subscriber devices.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. An access point for a time division duplex communication system that communicates with subscriber wireless devices at a first frequency and at a second frequency, the access point comprising:
a transceiver that transmits information to a first group of subscriber wireless devices at a first frequency and contemporaneously receives information from a second group of subscriber wireless devices at a second frequency during at least a portion of a first period of time, and that transmits information to the second group of subscriber wireless devices at the second frequency and contemporaneously receives information from the first group of subscriber wireless devices at the first frequency during at least a portion of a second period of time.

2. The access point according to claim 1, wherein the first period of time and the second period of time occur consecutively over time.

3. The access point according to claim 2, further comprising a transition period that separates the first period of time and the second period of time.

4. The access point according to claim 1, wherein the information comprises one or more of voice, text, data, video, sound, and graphics.

5. The access point according to claim 1, wherein the transmitting and receiving are in compliance with a standard protocol.

6. The access point according to claim 5, wherein the standard protocol is 802.16e.

7. A method for communicating in a time division duplex communication system that communicates with subscriber devices at a first frequency and at a second frequency, the method comprising:
transmitting information to a first group of subscriber devices at a first frequency during a first period of time;
receiving, contemporaneously with the transmitting to the first group, information from a second group of subscriber devices at a second frequency;
transmitting information to the second group of subscriber devices at the second frequency during a second period of time; and
receiving, contemporaneously with the transmitting information to the second group, information from the first group of subscriber devices at the first frequency.

8. The method according to claim 7, further comprising:
repeating
the transmitting at the first frequency contemporaneously with the receiving at the second frequency, and
the transmitting at the second frequency contemporaneously with receiving at the first frequency,
consecutively over time.

9. The method according to claim 7, further comprising waiting for a transition period after transmitting the information to the first group and before transmitting the information to the second group.

10. The method according to claim 7, wherein the information comprises one or more of voice, text, data, video, sound, and graphics.

11. The method according to claim 7, wherein the transmitting and receiving are in compliance with a standard protocol.

12. The method according to claim 11, wherein the standard protocol is 802.16e.

13. A computer program product for facilitating communication within a time division duplex communication system, the computer program product comprising:
a storage medium readable by a processing circuit and storing instructions for execution by the processing circuit for performing a method comprising:
transmitting information to a first group of subscriber devices at a first frequency during a first period of time;
receiving, contemporaneously with the transmitting to the first group, information from a second group of subscriber devices at a second frequency;
transmitting information to the second group of subscriber devices at the second frequency during a second period of time; and
receiving, contemporaneously with the transmitting information to the second group, information from the first group of subscriber devices at the first frequency.

14. The computer program product according to claim 13, further comprising:
repeating the transmitting and receiving steps consecutively over time.

15. The computer program product according to claim 13, further comprising:
waiting for a transition period after transmitting the information to the first group and before transmitting the information to the second group.

16. The computer program product according to claim 13, wherein the information comprises one or more of voice, text, data, video, sound, and graphics.

17. The computer program product according to claim 13, wherein the transmitting and receiving are in compliance with a standard protocol.

18. The computer program product according to claim 17, wherein the standard protocol is 802.16e.
